(19) United States
(12) Patent Application Publication
(10) Pub. No.: US 2013/0030985 A1
(43) Pub. Date: Jan. 31, 2013

(54) SYSTEMS AND METHODS FOR IDENTIFYING ITEMS OF COLLATERAL AVAILABLE TO A CONSUMER PURSUANT TO PRE-QUALIFIED FINANCE TERMS THAT ARE CONSISTENT WITH CONSUMER SPECIFIED PAYMENT CRITERIA

(71) Applicants: Tarry E. Shebesta, Maineville, OH (US); Brian S. Clifton, Williamsburg, OH (US); Everett E. Platt, Florence, TX (US)

(72) Inventors: Tarry E. Shebesta, Maineville, OH (US); Brian S. Clifton, Williamsburg, OH (US); Everett E. Platt, Florence, TX (US)

(21) Appl. No.: 13/644,931

(22) Filed: Oct. 4, 2012

Related U.S. Application Data
(63) Continuation-in-part of application No. 13/090,179, filed on Apr. 19, 2011.

(51) Int. Cl. G06Q 40/02

(52) U.S. Cl. 705/38

(57) ABSTRACT

Customers are provided with item search results that take into account both item specifications submitted by the customer and payment specifications submitted by the customer, where satisfaction of the payment specifications includes identifying finance programs for which the customer is pre-qualified and that are available for given items.

### CROSS-REFERENCE

This application is a continuation-in-part of U.S. application Ser. No. 13/090,179, filed Apr. 19, 2011, which is incorporated herein by reference.

### TECHNICAL FIELD

The subject matter described herein relates to generation of finance offers and/or item search results that take into account available finance offers.

### BACKGROUND

Many consumers finance significant purchases, arranging credit to spread payments out over a period of time. For example, the majority of home, car or boat purchasers arrange financing to pay for such purchases. There is a significant market in providing credit or loans to such consumers. Facilitating marketing of such is advantageous to those parties who are willing to make such loans, as well as to consumers desiring to obtain credit for purchases.

### SUMMARY

The present system, method process and device for generating finance offers facilitates financial transactions and assists consumers in obtaining financing. The following brief summary section is provided to facilitate a basic understanding of the nature and capabilities of the present system and method. This summary section is not an extensive nor comprehensive overview and is not intended to identify key or critical elements of the present systems or methods or to delineate the scope of these items. Rather this brief summary is intended to provide a conceptual introduction in simplified form as an introduction for the more detailed description presented later in this document.

In an embodiment, the system and method described herein provide for generating pre-qualified finance offers via the Internet. Customer identifying information is used to obtain credit information related to customer creditworthiness. The system and method utilizes the credit information as well as information regarding the item in which the consumer has expressed an interest (e.g., item price) to identify one or more finance offers for which the consumer is prequalified in real time. These finance offers are presented to the consumer and may also be provided to the vendor of the item in which the consumer has expressed an interest.

In other aspects of the systems and methods, finance offers are generated based at least in part upon the credit information, available finance programs and/or one or more additional factors. Such additional factors can include availability and condition of a trade-in, manufacturer incentives, dealer or vendor incentives, and value of the item as collateral.

In another embodiment, a method involves obtaining customer desired or acceptable specification information related to an item desired by a customer, obtaining customer desired or acceptable payment information for the item desired by the customer, including customer desired or acceptable periodic payment information, searching one or more data stores to (i) identify items of collateral, if any, that satisfy the customer desired or acceptable specification information and (ii) identify finance programs, if any, that are available for the identified items of collateral, and determining which, if any, of the identified items of collateral are available for purchase or lease by the customer pursuant to financing terms (i) for which the customer is pre-qualified and (ii) that satisfy the customer desired or acceptable periodic payment information.

The details of one or more embodiments of system and method for generation of finance offers are set forth in the accompanying drawings and the description below. Other features, objects, and advantages will be apparent to a person having ordinary skill in the art from the description and drawings, and from the claims.

### BRIEF DESCRIPTION OF DRAWINGS

The present invention is described with reference to the accompanying drawings. In the drawings, like reference numbers indicate identical or functionally similar elements. Additionally, the left-most digit(s) of a reference number identifies the drawings in which the reference number first appears.

FIG. 1 depicts a block diagram of an embodiment of a system that generates pre-qualified finance offers.

FIG. 2 depicts a block diagram of another embodiment of a system that generates pre-qualified finance offers.

FIG. 3 depicts an embodiment of a user interface for a system that generates pre-qualified finance offers.

FIG. 4 depicts another embodiment of a user interface for a system that generates pre-qualified finance offers.

FIG. 5 is a flowchart depicting an embodiment of a method for presenting finance offers in accordance with the systems described herein.

FIG. 6 depicts an exemplary computer system that can be used to implement the systems and methods described herein.

FIG. 7 depicts an exemplary computing environment for the protocol interface system.

FIG. 8 is a flowchart depicting an embodiment of a method for presenting collateral items that satisfy a customer's desired payment requirements, taking into account finance offers for which the customer is qualified.

### DETAILED DESCRIPTION

Frequently customers are unable to afford to pay for products out of pocket and require financing to afford more costly goods and services, such as cars, boats, homes, electronic systems and the like. Facilitating financing offers on terms specific to the credit-worthiness of the customer reduces the inconvenience to customers in obtaining credit and increases the likelihood of a sale. The increased popularity of Internet or electronic commerce has seen users become more and more comfortable with researching products, shopping and entering into and completing transactions electronically. In embodiments, the systems and methods described herein allow customers to obtain financing offers via the Internet, including purchase money financing, encouraging commerce and facilitating transactions, including sales, leases and the like.

As described in further detail below, in multiple embodiments, systems and methods for generating pre-qualified finance offers are fully or partially integrated with a retailer or vendor's website. By incorporating, at least in part, the system into a vendor web page, potential buyers are able to view the particular finance options available to them and for which they are pre-qualified. As used herein, the term “pre-qualified” indicates that a determination has been made that the potential customer is credit worthy and financially able to qualify for a particular financial offer. Embodiments of the described systems and methods are capable of providing finance offers to potential buyers in real-time. This streamlines the transaction process for potential buyers and eliminates obstacles to vendor sales.

In embodiments, the described systems and methods provide real-time, approval of financing and specific financial offer terms to a customer. The customer's pre-qualified status can also be communicated to the vendor of the goods or services which the customer wishes to acquire. Pre-qualified status facilitates the transaction, allowing both the vendor and the customer to be sure that the customer can obtain financing for a transaction, and presenting the customer with terms of the financing upfront, allowing the customer to make an educated purchase decision.

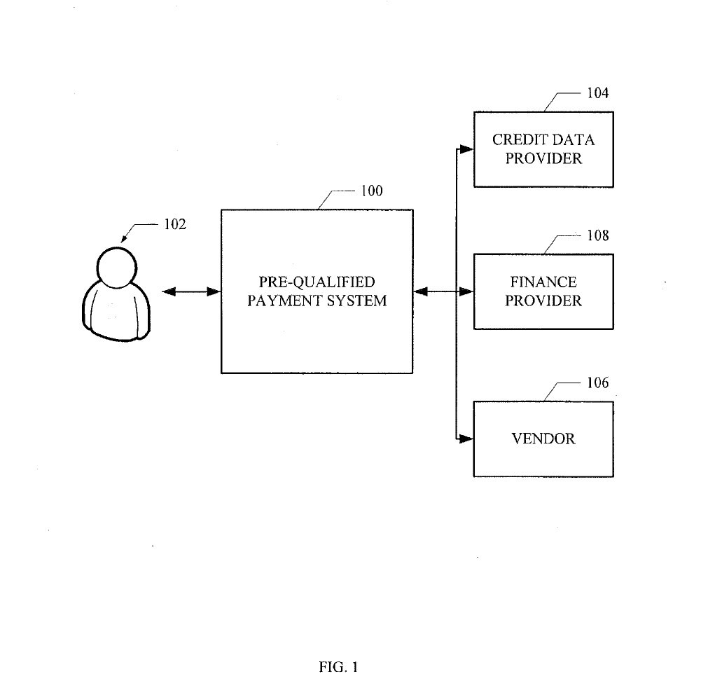

FIG. 1 depicts a high-level block diagram of an embodiment of a system 100 that generates pre-qualified finance offers. In an embodiment, a customer 102 provides input to the system 100, including but not limited to, customer identifying information (e.g., name, contact information, address information or any other information that may be used in identification of an individual or entity). In embodiments, the system 100 utilizes the provided customer identifying information to obtain customer credit information, including credit scores or any other indicia of the customer's creditworthiness or the customer's current or future ability to repay financed costs. In embodiments, the system 100 obtains such credit information from one or more credit data providers 104. For example, the system 100 can obtain a credit score from a credit bureau using the customer identifying information. Although a single credit data provider 104 is illustrated in FIG. 1, any number of credit data providers 104 may provide credit information. For example, the system 100 can obtain credit scores from multiple credit bureaus, such as Experian, TransUnion and Equifax.

In embodiments, the system 100 obtains information regarding an item or items which the customer desires to purchase, lease or otherwise acquire by financing the cost of the purchase. Although many of the examples described herein refer to sales transactions, embodiments of the system 100 are also capable of handling leasing, rental or other transaction types and are not limited solely to sales. For example, a leasing agency, either separate from or affiliated with the item vendor, provides a lease option to the consumer 102 that is a structured in a manner where the lessor retains title in the leased goods and the consumer 102 obtains a lease to the item in exchange for regular payments. This sort of transaction is akin to a financed purchase in that the lessor has an interest in minimizing credit risk posed by the consumer 102 while the vendor of the item wishes to facilitate the sale of the item. As used herein, the parties providing financing to the consumer 102 to facilitate the transaction may provide a variety of different financing options, including without limitations purchase money financing, un-secured financing, leases, rentals, and rent-to-own, among other options.

As used herein, an item can be any good or service, including but not limited to a car, truck, boat, house, or electronic good or services, such as installing windows, repainting a house or renting an apartment. Such items may serve as collateral for the financing, and are also referred to herein as the collateral. Item information can include an item description or identifier, price, resale value, discounts or sales incentives, predicted depreciation or any other information related to the item or items relevant to generation of a financing offer related to the transaction. The item information can also include the terms of the proposed transaction or transactions. For example, item information can indicate that the transaction is a sale, lease or rental.

In further embodiments, the item information can include related items, products or services that may be sold with the item selected by the customer 102. For example, in the context of car sales, dealers generally offer back-end sales products, such as a guaranteed asset protection (GAP) or insurance products, extended warranties, maintenance plans or any other products or services offered to customers. If elected by the customer 102, such back-end products or services can be incorporated in the total cost for which financing is sought.

In further embodiments, the system 100 obtains finance information from one or more finance providers 108. Finance providers 108 may include, but are not limited to, vendors, retailers, product manufacturers, financial institutions, and/or leasing companies. Finance information can include, but is not limited to, terms (e.g., length of repayment, interest rate), restrictions, rebates or other incentives. For example, a finance provider 108 may offer different terms based upon indicia of the customer's creditworthiness, such as credit score. Frequently, customers that are perceived as a higher risk of defaulting upon financing are charged increased interest rates to offset such risk. Use of independent credit information allows the finance provider 108 to better estimate the risk involved in offering financing to the customer 102 and set the terms accordingly.

In embodiments, the system 100 utilizes a combination of one or more of the credit information, item information and finance information to pre-qualify a customer 102 for one or more financial offers. In further embodiments, one or more financing offers from one or more finance providers 108 are presented to the customer 102 for review and possible selection. Furthermore, the financing offers or offer can be provided to the item vendor 106 as well. Confirmation that a potential customer 102 has obtained pre-qualified financing makes the customer 102 attractive to a vendor 106, facilitating the potential transaction.

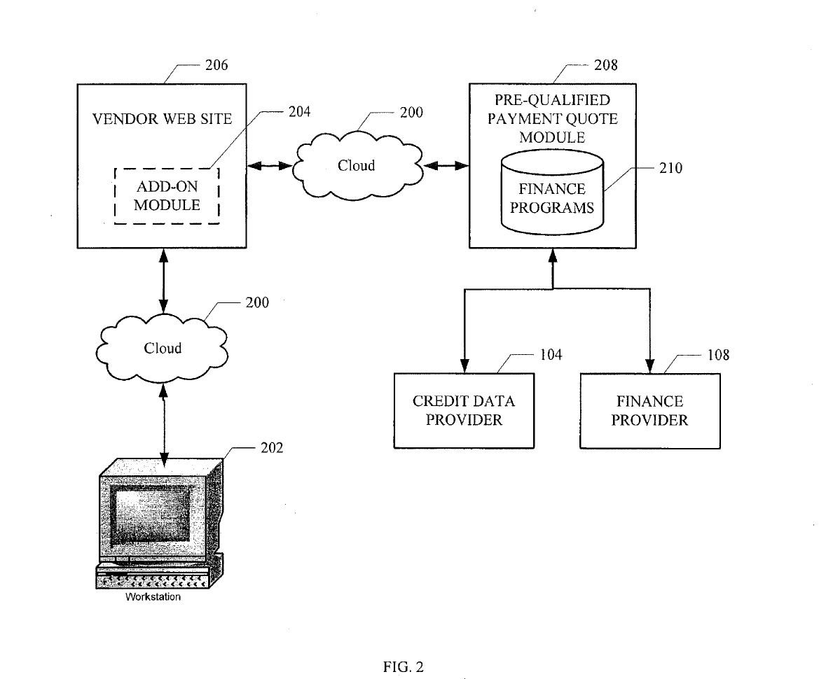

FIG. 2 depicts another embodiment of the system 100, also referred to herein as a Pre-qualified Payment System (“PPS”) that allows finance providers 108 to market finance programs over a network, such as the internet 200. As shown, a potential customer 102 accesses a vendor web page or site 206 via a network, such as the internet via a personal computer, tablet, smartphone or any other device 202 capable of accessing a website. In embodiments, the PPS includes a vendor plug-in or add-on module 204 that can be incorporated in, or used with the vendor's web site. In another embodiment, the vendor add-on module 204, also referred to herein as the add-on, includes software code that generates a user interface for a customer 102 to interact with the system 100. The add-on 204 can provide a customer selectable button or feature on which a customer can ‘click’ or otherwise select to view additional financing information and offers. For example, while reviewing a vendor's product information on the vendor's web site 206, the vendor web page 206 can include the system add-on 204. In this embodiment, the add-on 204 appears embedded in the vendor's web site 206. The add-on 204 can include an html hyper-link or similar web-based link to the remainder of the PPS 100. In other embodiments, the add-on 204 contains a calculated payment based at least in part on one or more of the customer data, the credit information, the finance program data, and the collateral data relevant to the webpage 206 where the add-on 102 resides. In still other embodiments, the add-on 204 includes executable code that queries other sources via the internet 200 and presents information to the user 102 in a form compatible with the web page 206 and facilitates interactions with the user 102.

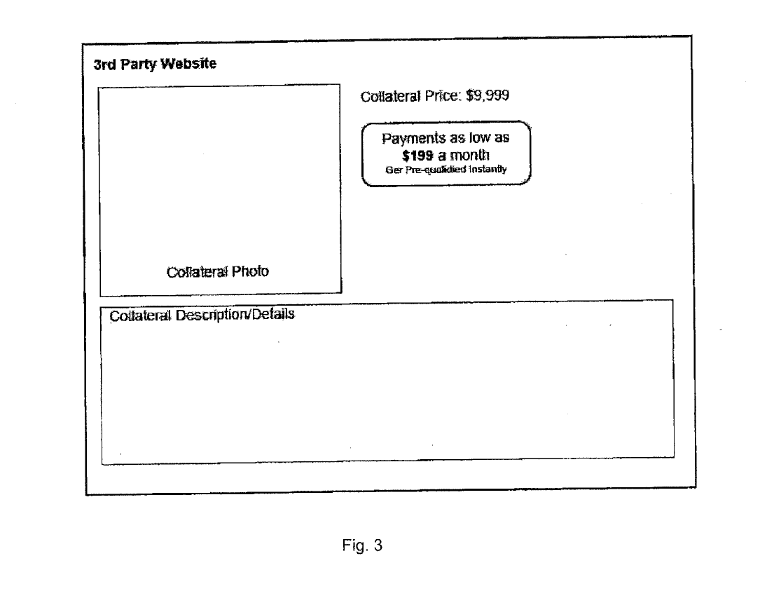

Referring now to FIG. 3, an embodiment of a user interface for an add-on 204 as incorporated in a vendor website 206 is illustrated. Here, the vendor website 206 displays product, collateral or item information, including pictures, descriptions, images, testimonials or any other vendor information. The exemplary add-on 204 is presented as a box within the web page that includes financing information, such as the lowest potential monthly payment for financing the presently depicted collateral. In other embodiments, the add-on 204 may be represented by a simple button, or may contain additional information, such as the name of the finance provider, potential interest rates, special offers and the like. In addition, the add-on 204 can contain a link or other customer selectable feature that allows a customer 102 to obtain additional information and generate finance offers.

Turning once again to FIG. 2, the add-on 204 can be provided to a vendor by the PPS 100, generated by the vendor itself, or via the third party website, such as an authorized reseller of the services. In embodiments, a pre-defined standard for the add-on 204 is set by the PPS. Such standard can include specification of communications between the add-on 204 and the remainder of the PPS 100. In other embodiments, the individual add-on 204 utilizes unique identifiers that identify the relevant vendor, the appropriate finance program data as previously defined by the vendor, the third party website, and/or the PPS 100.

In other embodiments, collateral data may be contained within the add-on 204, and passed to the rest of the system 100 upon selection of the add-on 204 by a customer 102. Alternatively, a unique identifier can be provided for identifying the collateral data based on data provided to the PPS 100 by the vendor 106, third party website and/or an outside data provider. In an embodiment, the add-on 204 generates a general button or feature that informs the visitor that pre-qualified payments are available if collateral data 108 is not available on the page where the add-on 204 resides.

In the illustrated embodiment, the PPS 100 includes a Pre-qualified Payment Quoting Module (“PPQM”) 208. Here, the PPQM 208 receives customer data, such as a customer's credit score or file. The PPQM 208 can request credit information from a credit data provider 104 using any available method of data retrieval. Customer credit information may be provided to the PPS 100 by a credit data provider 104, such as a credit reporting agency, the vendor, a third party website, or an outside data provider. Additionally, the PPQM 208 receives collateral or item data using any web standard method of data retrieval from the vendor 106, a third party website, or an outside data provider. In one embodiment the PPQM 208 retrieves the item data from the vendor 106 via a web standard method of data retrieval, in one embodiment the PPQM 208 performs a remote function call on a server operated by the vendor 106 to obtain the item data. In another embodiment the PPQM 208 accesses a data store to obtain item data via an Application Programming Interface (API). In still another embodiment the PPQM 208 obtains a portion of the item data from the vendor 106, such as a unique identifier—SKU or serial number and purchase price details, and secondary item data from yet another source, such as a credit-risk or loss exposure profile associated with the item.

In certain embodiments, the item and customer information includes data regarding the potential sales tax from a transaction. The customer information can indicate the geographic location of the sale (e.g., address or zip code). As shown in FIG. 3, the customer 102 is prompted to enter a zip code. In combination with the item price, the system 100 calculate potential sales tax based upon sales tax rate information for the particular geographic location.

In embodiments, the PPQM 208 includes a finance program data store 210. As used herein, a data store is a collection of data (e.g., a database, one or more files). While shown as incorporated within the PPQM 208, in other embodiments the finance program data store 210 is independent of the PPQM 208. In embodiments, finance program data is retrieved by the PPQM 208 from the finance program data store 210 based upon the particular vendor 106, such that only those financial programs suitable for the vendor 106 are evaluated and provided to the customer 102. The financial program data store 210 maintains finance program information which may be previously specified by the vendor 206 or third party finance provider 108. In another embodiment, the finance program information is retrieved from one or more finance providers 108 upon receipt of customer information. The finance program data includes information regarding potential finance offers, such as available rates, conditions on availability of certain offers, and the like.

In another embodiment, finance program information is obtained from a third party, such as a manufacturer of the item or collateral. For example, if the system 100 is used in the context of car sales, an individual car dealer may act as a vendor 106, providing item information such as pricing of an automobile to the system 100. In addition, the automobile manufacturer may provide additional incentives, rebates or financing offers. Such information can be utilized by the PPQM to calculate financing amount and options.

Utilizing the customer data, the collateral or item data, and the finance program data, the PPQM 208 calculates an available finance offer. Finance offers may include the finance source, payment, term, rate, fees, disclosures, and/or any other relevant data as defined by the PPS 100, vendor 106, and/or finance provider 108. The PPQM 208 transmits the customer data, collateral data, and the finance offers to the vendor 106, third-party website, and/or an outside party. As used herein, transmissions between various elements of the system 100 are accomplished by means appropriate for the communication. For example, in one embodiment the transmission is routed via a secure, web-standard protocol, such as an HTTPS connection that is established with a secure socket layer (SSL) connection. Running on top of these network communication layers in for example is an application to facilitate the specific transfer of data, such as a web server transmitting web page information, or in other embodiments, queries being transmitted via remote function calls.

In another embodiment, once a customer's credit information has been obtained and the customer 102 has been pre-qualified for credit, this information can be used to determine finance offers for any item presented to the customer 102 on the vendor web site 206. For example, after the customer 102 has received a finance offer, when viewing alternative items on the vendor web site 206 the add-on 204 can display finance information, including a finance offer, based upon computations by the PPQM 208. Once the system 100 has received the customer information necessary to obtain the customer's credit information, the information can be used to determine potential financing for any number of items, without requiring the information be reentered.

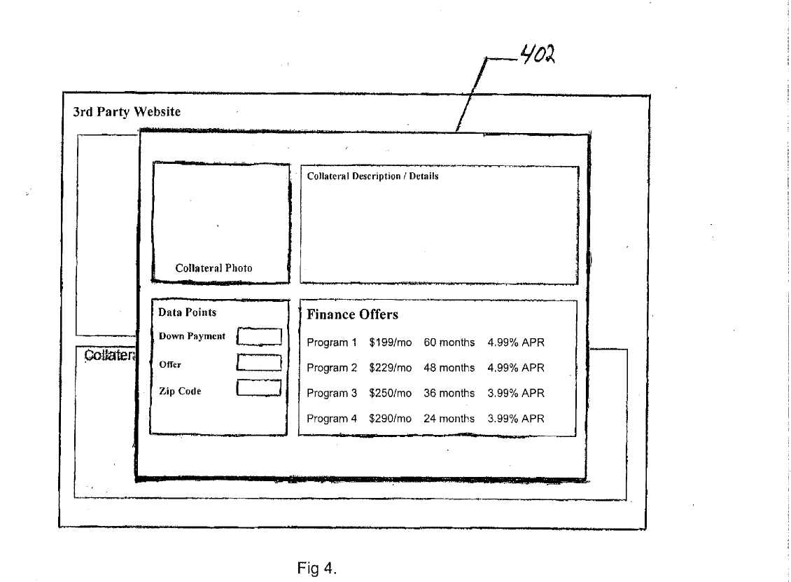

Turning now to FIG. 4, an exemplary PPQM customer user interface 402 is depicted. As shown, the customer user interface 402 can be displayed in a window that overlays the vendor website 206. In other embodiments, the customer user interface 402 is displayed in a separate browser window. The PPQM customer user interface 402 allows customers to interact with the PPQM 208 providing customer specific information and obtaining financing information and offers. As illustrated, the customer user interface 402 can display product or collateral information related to the vendor products, such as the particular product or collateral shown on the vendor web site 206 when the customer selected the add-on 204 to view financing information. In addition, the PPQM customer user interface 402 displays finance offer information. In the illustrated example, there are four (4) potential finance offers or options available to the customer 102. In embodiments, these offers are specific to the individual customer 102 and are provided based upon the PPQM's 208 analysis of customer information, credit information and/or collateral information. As described above, different offers may be made available based upon creditworthiness (e.g., credit score), and the collateral (e.g., price). In other embodiments, the customer 102 is able to modify certain factors in the financing, such as the loan (e.g., 24 months, 36 months, or 48 months), and down payment amount. The customer 102 can adjust these factors calculating and recalculating monthly payments. In another embodiment, the vendor can provide one or more messages to be presented to the customer 102 within the PPQM customer user interface 402. Here, a message can include text, an image, audio or a video to be presented to the customer 102. Such messages can be passed to the PPQM 208 from the add-on. For example, the vendor 106 may include a message providing information on a particular special or sale being offered by the vendor 106. In a further embodiment, the vendor 106 can include information on alternative items, such that the customer 102 can be presented with alternative options and finance offers related to those alternatives.

In a further embodiment, the PPQM customer user interface 402 provides a customer with the ability to schedule an appointment with a sales representative of the vendor 106 to obtain additional information or complete the contemplated transaction. The customer user interface 402 can provide a calendar appointment function allowing the customer 102 to select from available times. In an embodiment, the vendor 106 can set guidelines regarding the days and hours available for appointments and place a limit on the number of appointments at a given time. Alternatively, the PPQM customer user interface 402 calendar function can be synchronized with sales representatives' or vendor's calendar tools to schedule appointments for customers 102.

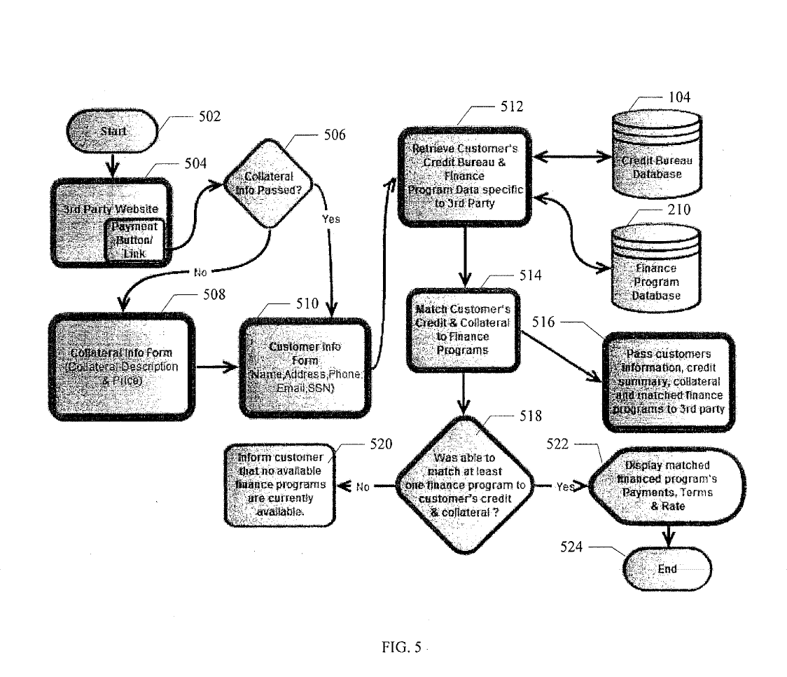

With reference to FIG. 5, a flowchart depicting a methodology associated with pre-qualified payment processing is illustrated. For simplicity, the flowchart is depicted as a series of steps or acts. However, the methodologies are not limited by the number or order of steps depicted in the flowchart and described herein. For example, not all steps may be necessary; the steps may be reordered, or performed concurrently and additional steps may be incorporated in the methodology. However, in one embodiment, the steps are performed sequentially.

Turning now to FIG. 5, an exemplary methodology for providing pre-qualified payment finance offers 500 is illustrated. Beginning at step 502, the add-on 204 is provided to a vendor 106 for use in the vendor website 206. At 504, the add-on 204 is incorporated or utilized in conjunction with a vendor or third-party website 206. In an embodiment, the add-on 204 is presented as a button or link prompting the user to select the add-on 204 for information regarding potential financing offers. In embodiments, the add-on 204 is customized based upon the particular items or products currently displayed on the vendor web site 206. Alternatively, a general offer of financing information may be displayed via the add-on 204.

Upon selection of the add-on 204 by the customer 102, information is passed to the PPQM 208. Such information can include information identifying the vendor 106, item or collateral information, and customer information. At step 506, a determination is made as to whether item or collateral information related to the collateral which the customer was viewing was provided to the PPQM 208. If the collateral information was not provided, the PPQM 208 can provide a collateral information form, prompting the user to enter collateral information such as price and description. Alternatively, this information can be requested from the vendor 106. In other embodiments, the PPQM or PPS retains information on the vendor's products, or collateral. Upon selection by a customer 102, a unique identifier for the particular item is passed to the PPS system 100, and this identifier can be used to retrieve the information from a data store.

After receipt of collateral information, at step 510 customer identifying information is obtained. In certain embodiments, identifying information is obtained directly from the customer 102. For example, a PPQM 208 or add-on 204 user interface can prompt the customer to enter their name, address or any other information sufficient to identify the customer. In other embodiments, the vendor 105 can provide customer identifying information. For example, if customer has provided identifying information to the vendor 106 for previous transactions or retains an account with the vendor 106, vendor 106 may supply such information to PPS 100.

At step 512, credit information and finance information are obtained. In particular, credit information can be obtained from one or more credit providers, such as a credit bureau, or from any other source useful in determining the creditworthiness of the customer. In addition, finance program information relevant for the vendor is obtained. Finance program information may be retrieved from the finance programs data store 210, or from finance providers 108. In embodiments, the finance programs data store 210 is periodically updated based upon changes to financing offers available from various finance providers 108.

Collateral information and credit information are processed or matched to available finance programs to generate offers applicable to the particular customer 102 at step 514. In an embodiment, finance offers available to the customer 102 are derived from the set of finance programs maintained by the PPS in the financial program data store 210 based upon programs offered by one or more finance providers 108. In another embodiment, the PPQM 208 queries the one or more finance providers 108 based upon collateral and credit information to obtain the relevant financial offer information. In an embodiment, at step 516 certain information related to the potential customer and financing offer is provided to the vendor 106 by the PPQM 208. Such information can include customer identifying data and collateral information, such as information identifying the customer 102 as a individual with an interest in particular collateral. This may allow the vendor 106 to follow-up with the customer 102 at a later time if the customer 102 does not complete a transaction during the visit to the vendor web site 206 or to provide additional item information. In addition, the credit information, and finance offer information can be provided to the vendor 106 as well. This would allow the vendor 106 to identify the individual as a potential customer with pre-qualified financing for the particular product or collateral.

At step 518, a determination is made as to whether the system 100 was able to match the customer 102 to a finance program based upon the credit information and collateral information. If not, at step 520 the customer 102 is informed that there is no financing offer currently available. If yes, then information regarding the matching financing offer or offers is presented to the customer 102 at step 524. As shown in FIG. 4, the user interface may allow the customer 102 to adjust certain factors, calculating and recalculating monthly payments based upon the down payment and term of the loan. The process ends at step 526 where the customer has been presented with the available finance offers, if any.

In a further embodiment, the system 100 is able to generate estimates or establish prices for the trade-in of customer goods. For example, new and used car buyers frequently sell or trade-in their existing automobile in the process of purchasing their next automobile. The value of the trade-in is deducted from the cost of the automobile to be purchased and thereby effects the amount of the financing required for such purpose. Accordingly, certain embodiments of the system 100 are capable of requesting trade-in information from the customer 102 via the user interface of either the PPQM 208 or the add-on 204 for use in generating relevant finance offers. For example, the user interface can display a request for trade-in information, if any. Customers can be prompted enter relevant information, such as make, model, year, mileage, condition, as well as any other information that may effect the value of the trade-in. For example, customers may be prompted to answer questions relevant to condition of a trade-in, such as presence of rust or dents on an automobile, The system 100 can utilize such information to determine the appropriate value for use in the financing calculations. For example, the PPQM 208 may include or access standard used model pricing information (e.g., bluebook value or blackbook value), decreasing such standard pricing based upon high mileage or poor condition. In an embodiment, the PPQM 208 determines a guaranteed price for the trade-in, such that as long as the trade-in is consistent with the information provided by the customer 102, the customer 102 will receive credit for the guaranteed price upon presenting the trade-in. In another embodiment, the vendor receives insurance from the party that manages the PPQM 208 to cover costs if the trade-in is inconsistent with the condition described by the customer 102.

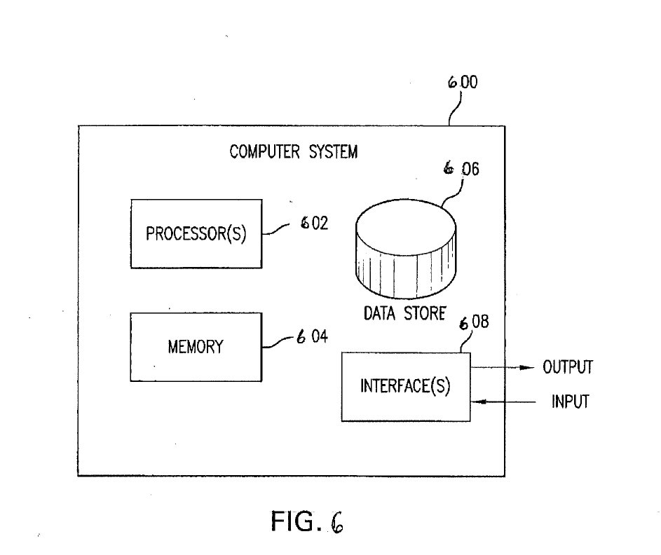

FIG. 6 depicts an exemplary computer system 600 that can be used to implement the PPS 100. As used herein, the term “exemplary” indicates an example, and does denote a preferred or optimal sample. The computer system 600 can be a laptop, desktop, server, handheld device (e.g., personal digital assistant (PDA), smart phone, etc.), programmable consumer or industrial electronics. As illustrated, the computer system 600 includes a processor 602, which can be any various available microprocessors. For example, the processor 602 can be implemented as dual microprocessors, multi-core and other multiprocessor architectures.

The computer system 600 includes memory 604, which can include volatile memory, nonvolatile memory, or both. Nonvolatile memory can include read only memory (ROM) for storage of basic routines for transfer of information, such as during boot or start-up of the computer. Volatile memory can include random access memory (RAM). The computer system 600 can include storage media 606, including but not limited to magnetic or optical disk drives, flash memory, and memory sticks.

The computer system 600 incorporates one or more interfaces 608, including ports (e.g., serial, parallel, PCMCIA, USB, and FireWire) or interface cards (e.g., sound, video, network, etc.) or the like. In embodiments, an interface 608 supports wired or wireless communications. Input is received from any number of input devices (e.g., keyboard, mouse, joystick, microphone, trackball, stylus, touch screen, scanner, camera, satellite dish, another computer system, etc.). The computer system 600 outputs data through an output device, such as a display (e.g. CRT, LCD, plasma, etc.), speakers, printer, another computer or any other suitable output device.

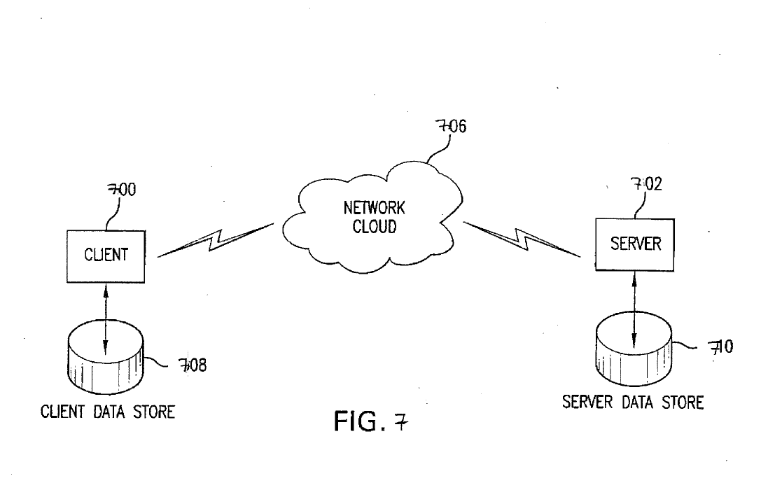

FIG. 7 depicts an exemplary computing environment for the system 100. The environment includes one or more clients 708, where a client 708 may be hardware (e.g., personal computer, laptop, handheld device, or other computing devices) or software (e.g., processes or threads). The environment also includes one or more servers 702, where a server 702 is software (e.g., thread or process) or hardware (e.g., computing devices), that provides a specific kind of service to a client 700. The environment can support either a two-tier client server model as well as the multi-tier model (e.g., client, middle tier server, data server and other models).

The environment also includes a communication framework 706 that enables communications between clients 700 and servers 702. In an embodiment, clients 700 correspond to local area network devices and servers are incorporated in a cloud computing system. A cloud is comprised of a collection of network accessible hardware and/or software resources. The environment can include client data stores 708 that maintain local data and server data stores 710 that store information local to the servers, such as the module library.

As noted above, the present system and method provides the ability to quickly and accurately generate pre-qualified finance offers for customers seeking to purchase an item such as a car, truck, RV or boat. In the world of online sales, readily adapting to a potential customer's requirements is critical. Often times a potential customer has a general idea regarding the nature of the item the customer desires to purchase, but desires to consider multiple options that fit that general idea. One of the most important considerations to almost every customer is item price. However, many customers, specifically customers that intend to finance a purchase, are more concerned with the periodic (e.g., weekly, monthly or quarterly) payment burden that will be undertaken, as opposed to the total price for the item being purchased. With that in mind, online systems have been previously developed that enable a customer to search for items that meet certain criteria, such as a monthly payment limit. Unfortunately, existing systems are not able to accurately provide the customer with true monthly payment information because such systems are not able to verify the nature and types of financing offers for which the customer is qualified. The present system and method provides a solution to that problem.

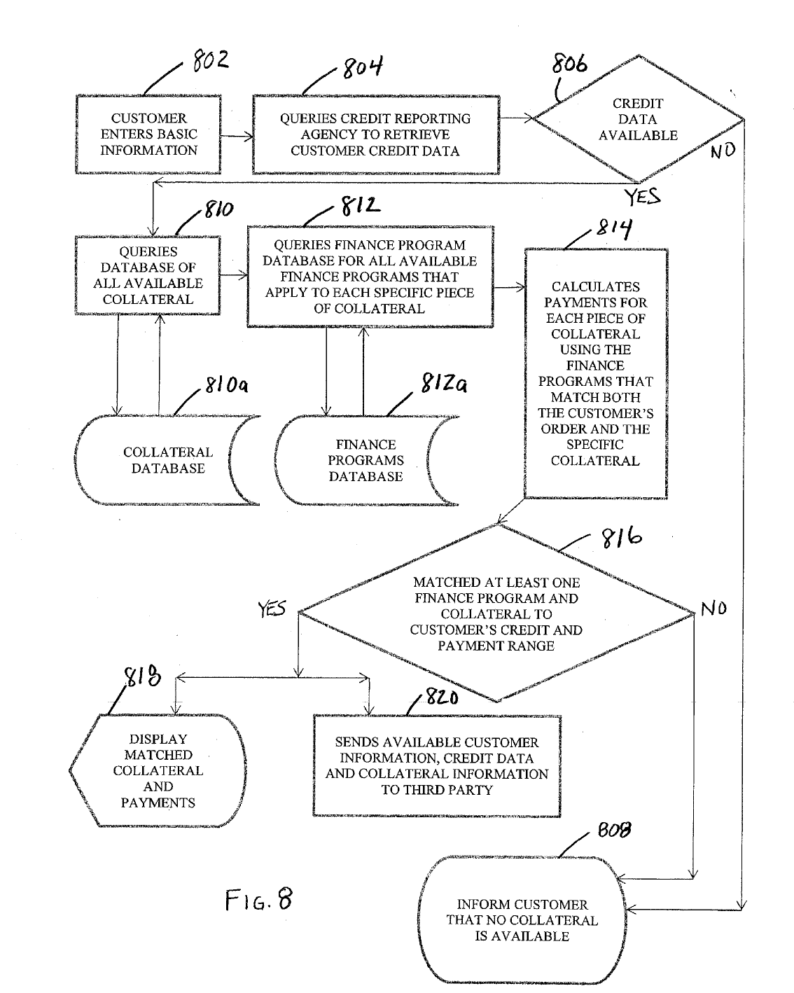

Referring now to FIG. 8, at step 802 a customer enters basic information, such as Name, Address, Income and desired Payment Range (e.g., $179-$199 per month) or acceptable Payment Limit (e.g., no more than $199 per month) for certain collateral the customer desires to purchase. Included in the customer submitted payment information may be desired Payment Duration Range (e.g., 24-36 months) or acceptable Payment Duration Limit (e.g., no more than 36 months), as well as desired Down Payment Range (e.g., $400 to $600) or acceptable Down Payment Limit (e.g., no more than $600). In one exemplary implementation, the customer enters the information directly via a web page interface (e.g., generated by a vendor web site 206, which may include add-on module 204 that generates the web page interface). In another exemplary implementation, a customer assistant may collect and enter the information for the customer (e.g., in the case of a customer calling by phone). In this regard, step 802 may take place before or after the customer has placed other restrictions on the collateral the customer desires to purchase. For example, prior to step 802 that customer may have already been presented with a web page interface (e.g., generated by module 204) that enabled the customer to identify the acceptable make(s), model(s), year(s) and/or type(s) of vehicles in which the customer has interest (or in the case of other types of collateral other information that will be used to focus a collateral search). Alternatively, such collateral specifying information could be requested, if at all, after step 802, or even on the very same web page in which the basic customer information is requested.

At step 804 the system queries the credit reporting agency and retrieves customer credit data. In one implementation, information is passed (e.g., under control of the module 204) from the vendor web site to the PPQM 208 for such purpose. If the credit data is not available per step 806, the PPQM notifies the module 204, and at step 808 the module informs the customer that no collateral is available to meet the customer's requirements and/or that sufficient credit data is not available to complete a search. If the credit data is available, processing moves to step 810 where the system queries a collateral database 810a for instances of collateral that satisfy any collateral specifications that have been submitted by the customer (e.g., the system, via module 204, passes the customer entered acceptable make(s), model(s), year(s) and/or type(s) of vehicle information to the database for use in searching the collateral data store for matching collateral). The result of the query will return details, including the selling price, of each item of identified collateral. At step 812, the system queries a finance program database 812a for all available finance programs, if any, applicable to each item of collateral returned in the query of step 810. In one implementation, this step involves the vendor web site passing (e.g., according to processing incorporated in the module 204) the results of the collateral query to the PPQM.

Based upon the returned collateral items and associated prices, the applicable finance programs identified as available for each collateral item and the customer's identified payment restrictions (e.g., desired Payment Range or acceptable Payment Limit and/or desired Payment Duration Range or acceptable Payment Duration Limit and/or desired Down Payment Range or acceptable Down Payment Limit), at step 814 the system calculates payments for each item of collateral using the finance programs available for that item of collateral and identifies any items of collateral where the finance program and payment meets the customer's identified payment restrictions. Again, such processing may take place via the module 204. Moreover, the system could also take into account trade-in information provided by the customer, as described above, to reduce the price of each item of collateral before calculating the payment information to be verified against the customer's identified payment restrictions.

If at least one satisfactory or matching collateral item and finance/payment arrangement is identified as per step 816, the matching collateral items and payment information are provided to the customer at step 818. In one implementation, the information is presented to the customer via a web page display generated by the module 204. In another implementation, the information is printed and mailed to the customer. At step 820, the customer information, credit data and collateral information may also be sent to a third party or parties (e.g., the vendor or vendors of the collateral items so that the vendor can follow-up with the customer). Per step 816, if no matching collateral items and payment information exist, at step 808 the customer is informed that no collateral is available to meet the customer's requirements.

The foregoing system and method provides the ability to present customer's with items of collateral that are known to meet both the customer's collateral specifications and the customer's payment specifications. Whereas, in the past, systems have permitted customer's to search for items by payment, the reality has been that any returned results may not have been truly available to the customer at those payment terms (e.g., because the payment assumed perfect credit and the searching customer had less than perfect credit). Utilizing the pre-qualification system described above with reference to FIGS. 1-7, the process of FIG. 8 can be carried out in a manner that returns results for the customer that the customer can truly rely upon. That is, the customer is not presented with any results that do not meet the customer's payment specifications, having taken into account the customer's credit and qualification for available finance programs that apply to the items of collateral.

The embodiments shown and described in the specification are only specific embodiments of inventors who are skilled in the art and are not limiting in any way. Therefore, various changes, modifications, or alterations to those embodiments may be made without departing from the spirit of the invention in the scope of the following claims.

What is claimed is:

1. A method for generating search results for a customer that take into account customer pre-qualification for financing, the method comprising:
(a) obtaining customer desired or acceptable specification information related to an item desired by a customer;
(b) obtaining identification information for the customer;
(c) obtaining customer desired or acceptable payment information for the item desired by the customer, including customer desired or acceptable periodic payment information;
(c) obtaining credit information related to the customer from a credit data provider based at least in part upon the customer identification information;
(d) searching one or more databases to (i) identify items of collateral, if any, that satisfy the customer desired or acceptable specification information and (ii) identify finance programs, if any, that are available for the identified items of collateral;
(e) based upon the results of the searching step and the customer desired or acceptable periodic payment information, a computer system determining which, if any, of the identified items of collateral of step (d)(i) are available for purchase or lease by the customer pursuant to financing terms (i) for which the customer is pre-qualified and (ii) that satisfy the customer desired or acceptable periodic payment information; and
(f) presenting the customer with information regarding one or more of the identified items of collateral determined in step (e) to be available for purchase or lease by the customer pursuant to financing terms (i) for which the customer is pre-qualified and (ii) that satisfy the customer desired or acceptable periodic payment information.

2. The method of claim 1 wherein step (f) includes providing the customer with both item specification information for the items of collateral and periodic payment information for the specific items of collateral.

3. The method of claim 2 wherein the customer desired or acceptable payment information includes customer desired or acceptable payment duration.

4. The method of claim 3 wherein step (f) includes providing the customer with payment duration information for the items of collateral.

5. The method of claim 1, further comprising:
obtaining trade-in information regarding a trade-in to be provided by the customer; and
taking into account reduced prices of the identified items of collateral when performing step (e).

6. The method of claim 1 wherein the credit data provider is a credit service bureau.

7. The method of claim 2 wherein in step (f) the customer is provided with periodic payment information for multiple finance options available to the customer for at least one item of collateral.

8. The method of claim 1 wherein the customer desired or acceptable payment information includes customer desired or acceptable down payment information.

9. A system for generating search results for a customer that take into account customer pre-qualification for financing, the system comprising:
(a) a computer system with memory and one or more associated processors for operating a vendor web site;
(b) an add-on module stored in the memory and including code to carry out the following steps:
(1) obtaining customer desired or acceptable specification information related to an item desired by a customer;
(2) obtaining identification information for the customer;
(3) obtaining customer desired or acceptable payment information for the item desired by the customer, including customer desired or acceptable periodic payment information;
(4) initiating a query to obtain credit information related to the customer from a credit data provider based at least in part upon the customer identification information;
(5) initiating a query to search one or more databases to (i) identify items of collateral, if any, that satisfy the customer desired or acceptable specification information and (ii) identify finance programs, if any, that are available for the identified items of collateral;
(6) based upon the results of the searching step and the customer desired or acceptable periodic payment information, determining which, if any, of the identified items of collateral of step (b)(5)(i) are available for purchase or lease by the customer pursuant to financing terms (i) for which the customer is pre-qualified and (ii) that satisfy the customer desired or acceptable periodic payment information; and
(7) presenting the customer with information regarding one or more of the identified items of collateral determined in step (6) to be available for purchase or lease by the customer pursuant to financing terms (i) for which the customer is pre-qualified and (ii) that satisfy the customer desired or acceptable periodic payment information.

10. A computer program product for generating search results for a customer that take into account customer pre-qualification for financing, the product comprising:
(a) a computer program storage medium; and
(b) a module stored on the storage medium and including code to carry out the following steps:
(1) obtaining customer desired or acceptable specification information related to an item desired by a customer;
(2) obtaining identification information for the customer;
(3) obtaining customer desired or acceptable payment information for the item desired by the customer, including customer desired or acceptable periodic payment information;
(4) initiating a query to obtain credit information related to the customer from a credit data provider based at least in part upon the customer identification information;
(5) initiating a query to search one or more databases to (i) identify items of collateral, if any, that satisfy the customer desired or acceptable specification information and (ii) identify finance programs, if any, that are available for the identified items of collateral;
(6) based upon the results of the searching step and the customer desired or acceptable periodic payment information, determining which, if any, of the identified items of collateral of step (b)(5)(i) are available for purchase or lease by the customer pursuant to financing terms (i) for which the customer is pre-qualified and (ii) that satisfy the customer desired or acceptable periodic payment information; and
(7) presenting the customer with information regarding one or more of the identified items of collateral determined in step (6) to be available for purchase or lease by the customer pursuant to financing terms (i) for which the customer is pre-qualified and (ii) that satisfy the customer desired or acceptable periodic payment information.

11. The product of claim 10 wherein the computer program storage medium comprises memory within a computer processing system.

12. The product of claim 10 wherein the computer program storage medium comprises a transportable data storage medium such as magnetic storage medium or an optical storage medium.

13. A system that generates search results for a customer that take into account customer pre-qualification for financing, comprising:
means for obtaining customer desired or acceptable specification information related to an item desired by a customer;
means for obtaining identification information for the customer;
means for obtaining customer desired or acceptable payment information for the item desired by the customer, including customer desired or acceptable periodic payment information;
means for obtaining credit information related to the customer from a credit data provider based at least in part upon the customer identification information;
means for searching one or more databases to (i) identify items of collateral, if any, that satisfy the customer desired or acceptable specification information and (ii) identify finance programs, if any, that are available for the identified items of collateral;
means for determining which, if any, of the identified items of collateral are available for purchase or lease by the customer pursuant to financing terms (i) for which the customer is pre-qualified and (ii) that satisfy the customer desired or acceptable periodic payment information; and
means for presenting the customer with information regarding one or more identified items of collateral determined to be available for purchase or lease by the customer pursuant to financing terms (i) for which the customer is pre-qualified and (ii) that satisfy the customer desired or acceptable periodic payment information.
